(19) United States
(12) Patent Application Publication
(10) Pub. No.: US 2006/0100961 A1
(43) Pub. Date: May 11, 2006

(54) Automated teller machine, a personal wireless device and methods of transferring funds therebetween

(75) Inventors: Robert P. Paterno, Richardson, TX (US); Leonardo W. Estevez, Rowlett, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/966,852

(22) Filed: Oct. 15, 2004

(51) Int. Cl. G06Q 40/00

(52) U.S. Cl. 705/43

(57) ABSTRACT

An automated teller machine (ATM), a personal wireless device (PWD) and methods of transferring funds therebetween. In one embodiment, the ATM includes (1) a user interface configured to receive direct input from a user, (2) a personal wireless device (PWD) authenticator associated with the user interface and configured to authenticate a PWD based on a unique identification code contained therein and (3) an order transmitter associated with the PWD authenticator and configured to employ the direct input to transmit an electronic funds transfer order to the PWD.

### TECHNICAL FIELD OF THE INVENTION

The present invention is directed, in general, to the use of electronic funds and, more specifically, to an automated teller machine, a personal wireless device and to methods of transferring funds therebetween.

### BACKGROUND OF THE INVENTION

Cellular telephones are widely used throughout the world for voice communications. In addition to voice communications, cellular telephones are also being used for other applications, such as, text messaging, game playing, Internet access, etc. Another use of cellular telephones is personal banking.

Banking customers can now use their cellular telephones to check their account balance, keep track of payments, receive notices when their balance declines to a certain limit and find out the latest finance rates. Additionally, some cellular telephones are connected to a service that allows sending money from one telephone to another based on telephone numbers.

In some markets, for example Finland, the cellular telephone is also used for point-of-sale (POS) transactions. A POS transaction refers to the ability of a user to buy items with a cellular telephone via a wireless sales transaction. The cellular telephone and a POS terminal (i.e., cash register), therefore, are adapted to wirelessly communicate therebetween. Essentially, the cellular telephone is used as a wireless debit card. Thus, a user can make a purchase at a store by using their cellular telephone instead of a debit card to wirelessly debit the amount of the purchase from an associated bank to the POS terminal. As with a conventional debit credit card system, a network is established that connects the POS terminal to the associated account allowing the amount of purchase to be subtracted therefrom.

Though convenient, using cellular telephones as a debit card raises several security issues. First, undesired access to the associated bank account is possible through wireless technology. Essentially, the cellular telephone exposes the full bank account to a wireless attack during a transaction. Additionally, trusting the banking system itself to properly monitor and maintain the account and the correct wireless transactions. Furthermore, security of the cellular telephone itself is a concern if the cellular telephone is stolen. Thus, even though the technology is available, security concerns can make it difficult to convince people to try.

Accordingly, what is needed in the art is a dependable method and system that allows cellular telephones to be used for point-of-sale transactions. More specifically, what is needed is a method and system that cellular telephone users trust to enable the use of cellular telephones for purchases.

### SUMMARY OF THE INVENTION

To address the above-discussed deficiencies of the prior art, the present invention provides an automated teller machine (ATM), a personal wireless device (PWD) and methods of transferring funds therebetween. In one embodiment, the ATM includes: (1) a user interface configured to receive direct input from a user, (2) a PWD authenticator associated with the user interface and configured to authenticate a PWD based on a unique identification code contained therein and (3) an order transmitter associated with the PWD authenticator and configured to employ the direct input to transmit an electronic funds transfer order to the PWD.

The direct input may include information from a bank card and a personal identification code. A bank card is unique card having account information that allows a user to access the account in conjunction with an associated personal identification code. For example, a bank card may be a conventional ATM card whereas the personal identification code is a personal identification number (PIN).

Thus, instead of using an ATM card and associated personal identification number (PIN) to withdraw cash from an account, the present invention allows a cellular telephone user to use the ATM card and PIN to authorize an electronic funds transfer order to the cellular telephone. A designated amount for transfer can be entered into the ATM and transferred from the account to the cellular telephone. The entire account, therefore, is not vulnerable on the cellular telephone but only a designated amount as input into the ATM by the user. Accordingly, the cellular telephone of the present invention can be used as cash instead of as a debit card.

Advantageously, the transfer to the cellular telephone is performed wirelessly. For security, the wireless transfer employs cryptographic technology. In addition, funds that have been transferred to the cellular telephone are protected by the cellular telephone's security, such as, a security system that requires a PIN or password before the cellular telephone can be accessed. The cellular telephone, therefore actually provides more security than cash since a thief would have to know the PIN or password before using the funds on the stolen cellular telephone.

Initializing the transfer of funds from the ATM to the cellular telephone is the same as withdrawing physical cash from the ATM. Thus, direct input at the ATM would still be required to authorize withdrawing funds from the account. Accordingly, users will feel comfortable and familiar with the transaction.

In another embodiment, the present invention provides a method of transferring funds including: (1) receiving direct input from a user into an ATM, (2) authenticating a PWD based on a unique identification code contained therein and (3) if the authenticating is successful, employing the direct input to transmit an electronic funds transfer order to the PWD.

In yet another embodiment, the present invention provides a PWD having a unique identification code including: (1) a transaction authenticator configured to communicate with an ATM to authenticate the PWD based on the unique identification code and direct input from a user at the ATM and (2) an order receiver associated with the ATM authenticator configured to receive an electronic funds transfer order from the ATM based on the direct input.

In still another embodiment, the present invention provides a method of transferring funds from a PWD having a unique identification code, including: (1) receiving direct input from a user into an ATM, (2) communicating with the ATM for authenticating the PWD based on the unique identification code and the direct input and (3) if the authenticating is successful, employing the direct input to transmit an electronic funds transfer order to the ATM.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of an automated teller machine (ATM) constructed according to the principles of the present invention;

FIG. 2 illustrates a block diagram of an embodiment of a personal wireless device (PWD) constructed according to the principles of the present invention;

FIG. 3 illustrates a flow diagram of an embodiment of a method of transferring funds carried out according to the principles of the present invention; and

FIG. 4 illustrates a flow diagram of an embodiment of a method of transferring funds from a PWD having a unique identification code carried out according to the principles of the present invention.

### DETAILED DESCRIPTION

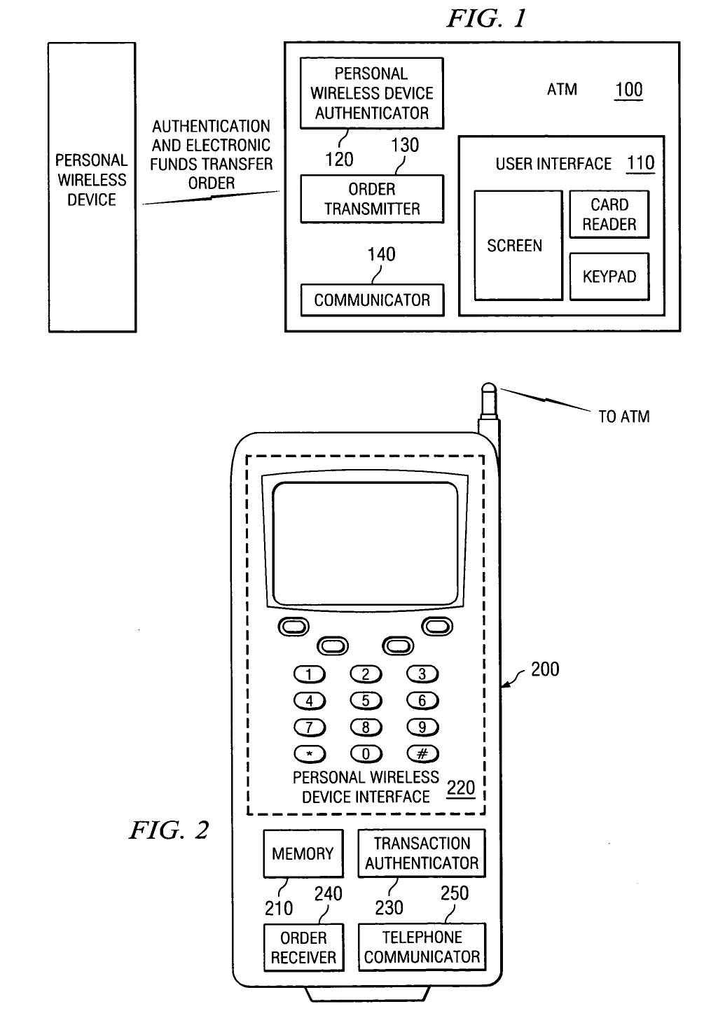

Referring initially to FIG. 1, illustrated is a block diagram of an embodiment of an automated teller machine (ATM), generally designated 100, constructed according to the principles of the present invention. The ATM includes a user interface 110, a personal wireless device (PWD) authenticator 120, an order transmitter 130 and a communicator 140. One skilled in the art will understand that the ATM 100 also includes additional components that are typically included in a conventional ATM, such as a central controller (microprocessor), that are not illustrated or discussed.

The ATM 100 is a conventional ATM having the added capability of communicating, or interacting, with a cellular telephone. Accordingly, the ATM 100 is an unattended machine specifically configured to provide banking services, including dispensing cash, based on information input at the ATM. The information input at the ATM, or direct input, is provided by a bank card and an associated personal identification code. The direct input will be discussed in more detail with respect to the user interface 110.

Typically, the ATM 100 is publicly accessible and may be designed for pedestrian or automobile traffic. The ATM 100, therefore, may be located inside a bank or at a drive-through associated with the bank. Additionally, the ATM 100 may be located in other locations other than a bank, such as, a mall, a grocery store, a restaurant, etc.

Even though the ATM 100 is a conventional ATM with added cellular telephone interactive capability, the present invention is not limited to the embodiment of the ATM 100. An ATM may be a multi-purpose machine that is not specifically designed as an ATM. For example, an ATM may be a general purpose computer that is publicly or privately accessible. In some embodiments, the ATM may be a personal computer that is coupled to the account through the Internet. In other embodiments, the ATM of the present invention may be specifically designed for transmitting electronic funds transfer orders and is not configured to dispense cash.

The user interface 110 is configured to receive direct input from a user. The user interface 110 includes a card reader, a keypad and a screen. The card reader is a common card reader of a conventional ATM. The card reader receives the bank card from the user and reads information therefrom. In some embodiments, the bank card is inserted into the card reader. In other embodiments, the bank card is read by being swiped through or proximate to the card reader. Of course, other types or configurations of card readers may be used.

The keypad and screen are also common components of a conventional ATM. Typically, a user inserts the bank card in the card reader and is then prompted for information via the screen. Through the keypad, the user directly inputs the requested information. The information may include the amount of funds to withdraw, the account from which to withdraw or other information related to accounts of the user. In addition, the direct input may include whether to dispense cash or transmit an electronic funds transfer order. An electronic funds transfer order represents an amount of funds from the selected account that is electrically transfer from the account. Thus, instead of physically withdrawing cash, a funds order representing the cash is transferred electronically. The transfer may be wirelessly or through a hardwired connection.

In some embodiments, the direct input may not include information from the bank card or the personal identification code. For example, the user interface 110 may receive information from the user through reading biometric information. The biometric information may be based on the user's fingerprint, eye, voice, etc. Additionally, the direct input can include a combination of biometric or bank card information that is input into the ATM. One skilled in the art will understand that the direct input can be entered into the ATM 100 through various methods and can include different information.

The PWD authenticator 120, associated with the user interface, is configured to authenticate a PWD based on a unique identification code contained therein. The PWD authenticator 120 may be implemented as a series of operating instruction, as hardware or as a combination thereof. The PWD authenticator 120 employs the communicator 140 to authenticate the PWD. By authenticating the PWD, the PWD authenticator 120 verifies that the PWD is assigned to the account provided by the direct input. The PWD may be assigned to the account through a software package provided by the manufacturer of the PWD to the bank. The software package allows the bank to access the unique identification code of the PWD and assign it to the account of the user. The correlation between the account of the user and the assigned PWD, or in some embodiments the PWDs, is then stored in the PWD authenticator 120.

The PWD authenticator 120 may authenticate the PWD through a well known cryptographic program. The PWD authenticator 120 may employ a public and private key of both the PWD and the ATM 100 to authenticate the PWD by sending a challenge thereto and comparing answers to the challenge from the PWD authenticator 120 and the PWD. If there is a match, then the PWD authenticator 120 authenticates the PWD as the designated PWD associated with the account information from the direct input.

The order transmitter 130, associated with the PWD authenticator 120, is configured to employ the direct input to transmit an electronic funds transfer order to the PWD. The order transmitter 130 may be implemented as a series of operating instruction, as hardware or as a combination thereof. In some embodiments, the order transmitter 130 or the PWD authenticator 120 may be configured as a portion of the microprocessor of the ATM 100. The order transmitter 130 employs the communicator 140 to transmit the electronic funds transfer order to the PWD. The order transmitter 130 wirelessly transmits the electronic funds transfer order employing a conventional cryptographic program. In some embodiments, the order transmitter 130 employs a digital signature when transmitting the electronic funds transfer order. The order transmitter 130 transmits after the PWD has been authenticated to minimize the wireless connection between the ATM 100 and the PWD.

The communicator 140 is a conventional wireless transceiver that is configured to communicate between the ATM 100 and the PWD. The communicator 140 may be configured to wirelessly communicate via infrared and various radio frequencies including Bluetooth®. In some embodiments, the communicator 140 may be configured to provide a hardwired connection between the ATM 100 and the PWD. For example, the ATM 100 and the PWD may be coupled through a universal serial bus (USB). Typically, the communicator 140 is employed by the order transmitter 130 and the PWD authenticator 120 to communicate with the PWD. One skilled in the art will understand the configuration and operation of the communicator 140.

Turning now to FIG. 2, illustrated is a block diagram of an embodiment of a personal wireless device (PWD), generally designated 200, constructed according to the principles of the present invention. The PWD 200 includes a memory 210, a PWD interface 220, a transaction authenticator 230, an order receiver 240 and a telephone communicator 250.

The PWD 200 is a cellular telephone. In other embodiments the PWD 200 may be another electronic device, such as, a personal digital assistant (PDA), an MP3 player, a laptop computer or a combination thereof. The PWD 200 includes a unique identification code that is assigned to the PWD 200 by the manufacturer and stored in a secure portion of the memory 210.

The memory 210 may be a conventional ROM memory typically used in a cellular telephone. The secure portion of the ROM (secure ROM) is a protected portion requiring special procedures and manufacturer identification to access. Typically, the unique identification code is loaded into the secure ROM during manufacturing of the PWD. Access to the secure ROM after manufacturing can be allowed through software provided by the manufacturer. For example, the PWD manufacturer can provide the bank associated with the user's account with the appropriate software package to allow the bank to assign the PWD to the account. One skilled in the art will understand the configuration of the secure ROM.

The PWD interface 220 includes a conventional keypad and screen that allows a user to interact with the PWD. The user may also interact with the PWD through a microphone and speaker that are not shown. In some embodiments, direct input may be entered through the PWD interface 220.

The transaction authenticator 230 is configured to communicate with an ATM to authenticate the PWD employing the unique identification code and the direct input. The transaction authenticator 230 may be implemented as a series of operating instruction, as hardware or as a combination thereof. The transaction authenticator 230 may process a challenge from the PWD authenticator 120 of FIG. 1 and return an answer thereto. To generate an answer, the transaction authenticator 230 employs the unique identification code of the PWD whereas the challenge is generated based on the direct input.

The transaction authenticator 230 is further configured to communicate with a POS terminal to authenticate the PWD during a transaction therebetween. In some embodiments, the POS terminal is connected through a network to a bank that verifies the PWD 200 having the unique identification code is assigned to an account. The POS terminal can then send the amount of funds transferred for the transaction from the PWD 200 (the order receiver 240) to the associated account for electronic payment.

If the POS terminal does not have a network connection (e.g., a vending machine), then authentication of the PWD 200 and delivery of electronic funds transfer order from the PWD 200 to the associated bank account is more complex. In such cases, the POS terminal could be periodically updated with the latest database information pertaining to bank accounts and associated PWDs (e.g., by the vending machine stocker). Accordingly, the unique identification code of the PWD 200 could still be used for authentication to mitigate risk. Additionally, the unique identification code may be tracked and rated for trustworthiness. The unique identification code, therefore, associated with a number of bad transactions may not be authenticated and the transaction could be denied.

The order receiver 240, associated with the transaction authenticator 230, is configured to receive an electronic funds transfer order from the ATM based on the direct input. The transaction authenticator 230 may be implemented as a series of operating instruction, as hardware or as a combination thereof. Once the PWD 200 has been authenticated, the order receiver 240 accepts the designated amount of electronic funds transfer order from the ATM. Additionally, the order receiver 240 is configured to manage the electronic funds transfer order by maintaining the balance thereof through various purchases or deposits into the account at the ATM. Thus, the order receiver 240 is also configured to transmit an electronic funds transfer order to the ATM or to the POS terminal. If to the POS terminal, the electronic funds transfer order is sent to the associated bank account for payment.

The telephone communicator 250 is a conventional wireless transceiver that is configured to communicate with the ATM. The ATM and the telephone communicator 250 are configured to support a wireless connection employing a secure protocol. In some embodiments, the telephone communicator 250 may be configured to communicate with the ATM through a hardwired connection such as a USB. The transaction authenticator 230 and the order receiver 240 may employ the telephone communicator 250 to communicate with the ATM.

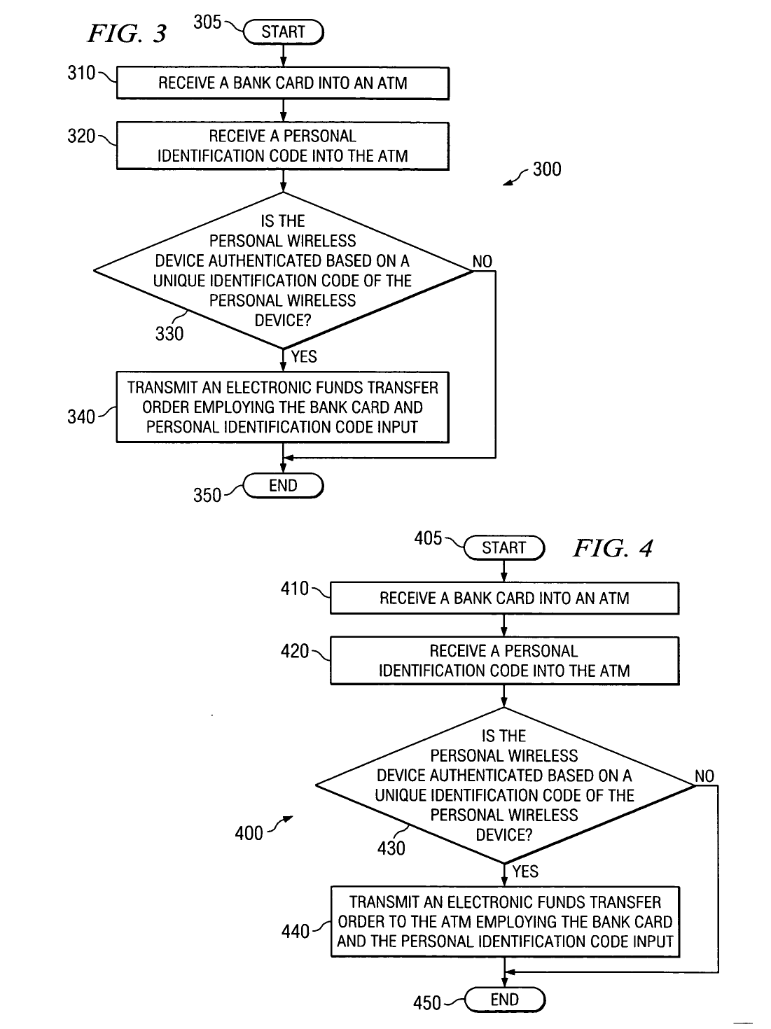

Turning now to FIG. 3, illustrated is a flow diagram of an embodiment of a method of transferring funds, generally designated 300, carried out according to the principles of the present invention. The method 300 begins with an intent to transfer funds in a step 305.

After beginning, a bank card is received into an ATM from a user in a step 310. The bank card may be inserted into the ATM in order to be read. Alternatively, information stored on the bank card can be read by scanning the bank card through or proximate to a card reader. The ATM may be an unattended machine configured to dispense cash to users.

After receiving the bank card, a personal identification code is received into the ATM in a step 320. The personal identification code is associated with the bank card and may be received through a keypad of the ATM. Typically, the personal identification code is a personal identification number (PIN) that is receive through user input via the keypad. Alternatively, the personal identification code may be received via a biometric scanner. The ATM may be configured to dispense the cash based on both the bank card information and the personal identification code that is received.

After receiving the personal identification code, a determination is made if the PWD is authenticated based on a unique identification code contained therein in a decisional step 330. The ATM authenticates the PWD to insure that the bank card, the personal identification code and the PWD are associated. The ATM may authenticate the PWD through a wireless transceiver employing conventional cryptographic technology. For wireless authentication, the PWD is sufficiently proximate to the ATM depending on the wireless technology employed. The unique identification code may be stored in a secure ROM section of the PWD.

If authentication of the PWD is successful, an electronic funds transfer order is transmitted to the PWD employing the direct input in a step 340. The amount of the electronic funds transfer order may be based on an amount received through the keypad by the user. For example, the ATM may prompt the user requesting a dollar amount to transfer. In response, the user may input $40.00. Accordingly, the ATM then transmits a $40.00 electronic funds transfer order to the PWD. The $40.00 of funds on the PWD may then be used for purchases. The electronic funds transfer order may be transmitted wirelessly. Accordingly, the PWD is sufficiently proximate to the ATM.

After transmitting the electronic funds transfer order, the method of transferring funds ends in a step 350. Returning now to the decisional step 330, if the authentication is not successful, the method proceeds to the step 350 and ends. Thus, funds are not transferred unless the PWD is a valid PWD associated with the bank card and the personal identification code.

Turning now to FIG. 4, illustrated is a flow diagram of an embodiment of a method of transferring funds from a PWD having a unique identification code, generally designated 400, carried out according to the principles of the present invention. The method 400 begins with an intent to transfer funds from the PWD in a step 405.

After beginning, a bank card is received into an ATM from a user in a step 410. Information from the bank card may read by the ATM by inserting or scanning the bank card ATM. Alternatively, instead of employing a bank card, the ATM may read biometric information from a user that is associated with account information of the user.

After the ATM receives the bank card, a personal identification code is received into the ATM in a step 420. The personal identification code is associated with the bank card and may be received through a keypad of the ATM. The personal identification code may be a personal identification number (PIN). Alternatively, the personal identification code may be biometric information.

After the ATM receives the personal identification code, the PWD communicates with the ATM to determine if the PWD is authenticate based on a unique identification code contained therein in a decisional step 430. The PWD is authenticated by the ATM to insure that the PWD is associated with the bank card and the personal identification code. The PWD may be authenticated wirelessly employing a wireless transceiver and conventional cryptographic technology. The unique identification code may be stored in a secure ROM section of the PWD.

If authentication of the PWD is successful, the PWD transmits an electronic funds transfer order to the ATM employing the direct input in a step 440. The amount of the electronic funds transfer order is based on an amount received through the keypad by the user. The electronic funds transfer order may be transmitted wirelessly employing cryptographic technology. During communications with the ATM, the PWD is sufficiently proximate to the ATM based on the wireless technology that is being used.

After transmitting the electronic funds transfer order, the method of transferring funds ends in a step 450. Returning now to the decisional step 430, if the authentication is not successful, the method proceeds to the step 450 and ends. Thus, funds are not transferred from the PWD to the ATM unless the PWD is a valid PWD associated with the bank card and the personal identification code that is input at the ATM.

As discussed with respect to the above embodiments, the present invention provides an ATM, a PWD and methods to limit exposure of an account but yet still enable a PWD to be used as cash for purchases. Additionally, the present invention provides a familiar procedure to withdraw funds from an account onto the PWD. Accordingly, the present invention allows a user more control over the balance of funds on their PWD.

Although the present invention has been described in detail, those skilled in the art should understand that they can make various changes, substitutions and alterations herein without departing from the spirit and scope of the invention in its broadest form.

What is claimed is:

1. An automated teller machine (ATM), comprising:
a user interface configured to receive direct input from a user;
a personal wireless device (PWD) authenticator associated with said user interface and configured to authenticate a PWD based on a unique identification code contained therein; and
an order transmitter associated with said PWD authenticator and configured to employ said direct input to transmit an electronic funds transfer order to said PWD.

2. The ATM as recited in claim 1 wherein said authenticate and said transmit are performed wirelessly.

3. The ATM as recited in claim 1 wherein said ATM is an unattended machine configured to dispense cash based on said direct input.

4. The ATM as recited in claim 1 wherein said user interface is configured to receive said direct input from said user employing a bank card and a personal identification code at said ATM.

5. The ATM as recited in claim 1 wherein said direct input determines an amount of said electronic funds transfer order.

6. The ATM as recited in claim 1 wherein said order transmitter is further configured to receive said electronic funds transfer order from said PWD.

7. A method of transferring funds, comprising:
receiving direct input from a user into an automated teller machine (ATM);
authenticating a PWD based on a unique identification code contained therein; and
if said authenticating is successful, employing said direct input to transmit an electronic funds transfer order to said PWD.

8. The method as recited in claim 7 wherein said authenticating and said transmit are performed wirelessly.

9. The method as recited in claim 7 wherein said ATM is an unattended machine configured to dispense cash based on said direct input.

10. The method as recited in claim 7 wherein said receiving includes receiving a bank card and a personal identification code at said ATM from said user.

11. The method as recited in claim 7 further comprising determining an amount of said electronic funds transfer order based of said direct input.

12. A personal wireless device (PWD) having a unique identification code, comprising:
a transaction authenticator configured to communicate with an ATM to authenticate said PWD employing said unique identification code and direct input from a user at said ATM; and
an order receiver associated with said ATM authenticator configured to receive an electronic funds transfer order from said ATM based on said direct input.

13. The PWD as recited in claim 12 wherein said communicate and said receive are performed wirelessly.

14. The PWD as recited in claim 12 wherein said ATM is an unattended machine configured to dispense cash based on said direct input.

15. The PWD as recited in claim 12 wherein said direct input is from said user employing a bank card and a personal identification code at said ATM.

16. The PWD as recited in claim 12 wherein said direct input determines an amount of said electronic funds transfer order.

17. The PWD as recited in claim 12 wherein said order receiver is further configured to transmit said electronic funds transfer order to said ATM.

18. The PWD as recited in claim 12 wherein said transaction authenticator is further configured to communicate with a point-of-sale terminal to authenticate said PWD.

19. A method of transferring funds from a personal wireless device (PWD) having a unique identification code, comprising:
receiving direct input from a user into an automated teller machine (ATM);
communicating with said ATM to authenticate said PWD based on said unique identification code and said direct input; and
if said authenticating is successful, employing said direct input to transmit an electronic funds transfer order to said ATM.

20. The method as recited in claim 19 wherein said authenticating and said transmit are performed wirelessly.

21. The method as recited in claim 19 wherein said ATM is an unattended machine configured to dispense cash based on said direct input.

22. The method as recited in claim 19 wherein said direct input is from said user employing a bank card and a personal identification code at said ATM.

23. The method as recited in claim 19 wherein said direct input determines an amount of said -electronic funds transfer order.
